(19) United States
(12) Patent Application Publication
(10) Pub. No.: US 2002/0105891 A1
(43) Pub. Date: Aug. 8, 2002

(54) Optical pickup apparatus

(76) Inventors: Ju-hyung Lee, Gyeonggi-do (KR); Hyun-seob Choi, Gyeonggi-do (KR)

Correspondence Address: STAAS & HALSEY LLP, 700 11TH STREET, NW, SUITE 500, WASHINGTON, DC, 20001, US

(21) Appl. No.: 09/963,677

(22) Filed: Sep. 27, 2001

(30) Foreign Application Priority Data
Feb. 3, 2001 (KR) 2001-5258

(51) Int. Cl. G11B 7/135

(52) U.S. Cl. 369/112.17

(57) ABSTRACT

An optical pickup apparatus including first and second light sources emitting first and second light beams, respectively, each light beam including different wavelengths; first and second optical path converters changing optical paths of the first and second light beams, respectively; an objective lens, arranged next to the first and second optical path converters, focusing a divergent light beam from one of the first and second optical path converters on one of a relatively thin disc and a relatively thick disc; and a photodetector receiving the divergent light beam from the first and second optical path converters after being reflected by the optical recording medium, wherein the optical pickup is exclusive of a collimating lens.

### CROSS-REFERENCE TO RELATED APPLICATIONS

This application claims the benefit of Korean Application No. 2001-5258, filed Feb. 3, 2001, in the Korean Industrial Property Office, the disclosure of which is incorporated herein by reference.

### BACKGROUND OF THE INVENTION

1. Field of the Invention

The present invention relates to an optical pickup apparatus, and more particularly, to a compact optical pickup apparatus adopting a finite system objective lens to reduce a number of components in the optical pickup apparatus.

2. Description of the Related Art

For compatibility, an optical recording/reproducing apparatus for a digital versatile disc for recording/reproducing information at a high density is needed to record/reproduce information on/from a compact disc (CD) and a CD family, such as a CD-R (compact disc-recordable), a CD-RW (compact disc-rewritable), a CD-I (compact disc-interactive), a CD-G (compact disc-graphics), as well as on/from a digital versatile disc (DVD).

While the standard thickness of a conventional CD-family disc is 1.2 mm, the standard thickness of a DVD disc is 0.6 mm, considering allowance in inclination of the DVD disc and a numerical aperture of an objective lens. Thus, when information is recorded/reproduced by the optical pickup apparatus for a DVD on/from a CD, spherical aberration occurs due to difference in thickness between the DVD and the CD discs. Due to the spherical aberration, a sufficient strength of light needed to record an information signal cannot be obtained and an information signal recorded on the CD disc may be deteriorated during reproduction. Also, the wavelength of a light source to reproduce the information signal recorded on the conventional CD family is about 780 nm, while the wavelength of the light source to reproduce the information signal recorded on the DVD is about 650 nm. Thus, light sources emitting light at different wavelengths and a compatible optical pickup apparatus having a structure so that an optical spot can be formed at different focal positions are needed.

Referring to FIG. 1, a conventional compatible optical pickup apparatus includes a first light source 10 for emitting light having a wavelength of about 650 nm and a second light source 20 for emitting light having a wavelength of about 780 nm. The first and second light sources 10 and 20 are disposed at different positions. The first light source 10 is used for a relatively thin disc 50, such as a DVD whereas the second light source 20 is used for a relatively thick disc 52, such as a CD.

A light beam emitted from the first light source 10 is emitted towards a first beam splitter 15 and is reflected by the first beam splitter 15 to proceed towards the relatively thin disc 50. The light beam reflected by the relatively thin disc 50 passes through the first beam splitter 15 and is received by a photodetector 60. In turn, a light beam emitted from the second light source 20 passes through a grating 25 and is reflected by a second cubic beam splitter 30 and an optical light spot is formed on the relatively thick disc 52.

A reflection mirror 35 is disposed between the discs 50, 52 and the first beam splitter 15 to change a path of the light beam emitted from the first or second light sources 10 and 20. A collimating lens 40 is disposed between the reflection mirror 35 and the discs 50, 52 to collimate incident diverging light beam from the first or second light sources 10, 20 transmitted or reflected by the reflection mirror 35. An objective lens 45 is disposed between the collimating lens 40 and the discs 50,52 and focuses the incident light beam on the relatively thin disc 50 or on the relatively thick disc 52.

The photodetector 60 receives the light reflected by the relatively thick disc 52 via the objective lens 45, the reflection mirror 35, the second cubic beam splitter 30, and the first beam splitter 15. A condensing lens 55 is installed between the first beam splitter 15 and the photodetector 60.

As described above, in the conventional optical pickup apparatus, because the collimating lens 40 is provided between the objective lens 45 and the reflection mirror 35 and the cubic beam splitter 30 is used, the overall volume of the optical pickup apparatus increases. Also, as the number of components in the optical pickup apparatus increases, cost increases, and the possibility of aberration and distortion increases.

### SUMMARY OF THE INVENTION

Various objects and advantages of the invention will be set forth in part in the description that follows and, in part, will be obvious from the description, or may be learned by practice of the invention.

To solve the above-described problems, it is an object of the present invention to provide for an optical pickup apparatus in which a finite system objective lens is used so that a number of components is reduced and free space increases for the components.

To achieve these and other objects, there is provided an optical pickup apparatus including: first and second light sources emitting first and second light beams, respectively, each light beam including a different wavelength; first and second optical path converters changing optical paths of the first and second light beams, respectively; an objective lens, arranged next to the first and second optical path converters, focusing a divergent light beam from one of the first and second optical path converters on a corresponding optical recording medium; and a photodetector receiving the light beam from the first and second optical path converters after being reflected from the optical recording medium.

For illustrative purposes, in the present invention at least one of the first and second optical path converters is a plate beam splitter to correct for aberration.

Also, to achieve the above and other objects, there is provided an optical pickup apparatus, including: first and second light sources emitting first and second light beams, respectively, each light beam having a different wavelength; first and second optical path converters changing optical paths of the first and second light beams, respectively; a reflection mirror, disposed next to the first optical path converter or the second optical path converter, to change the optical path of one of the first and second light beams; an objective lens, arranged between the reflection mirror and a corresponding optical recording medium, focusing a divergent light beam from one of the first and second optical path converters on the corresponding optical recording medium; and a photodetector receiving the light beam from the first and second optical path converters after being reflected from the optical recording medium.

These together with other objects and advantages, which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above object and advantages of the present invention will become more apparent by describing in detail preferred embodiments thereof with reference to the attached drawings in which:

FIG. 1 is a view showing an optical arrangement of a conventional optical pickup apparatus;

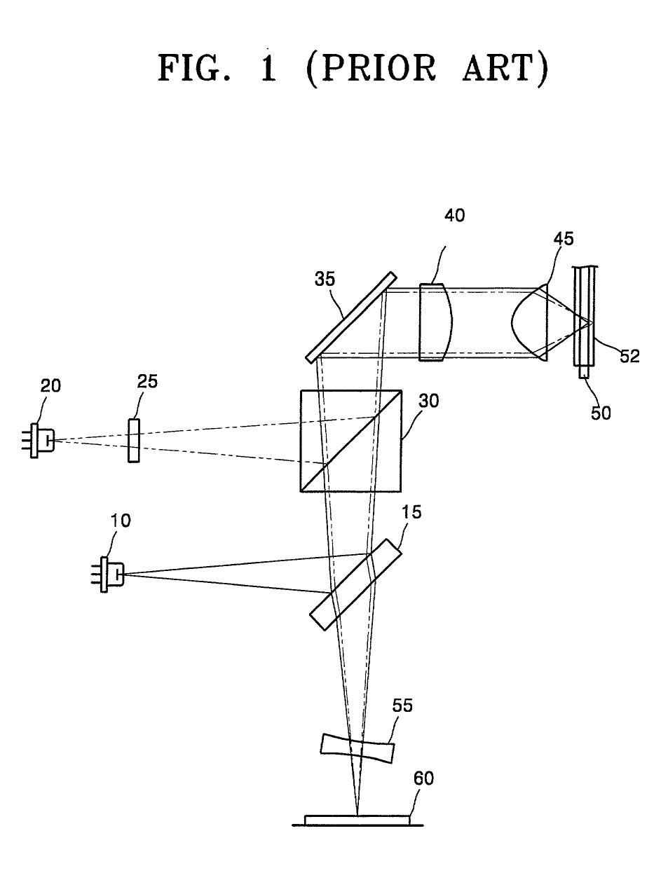

FIG. 2 is a view showing an optical arrangement of an optical pickup apparatus according to an embodiment of the present invention; and

FIG. 3 is a view showing an optical arrangement of an optical pickup apparatus according to another embodiment of the present invention.

### DETAILED DESCRIPTION OF THE INVENTION

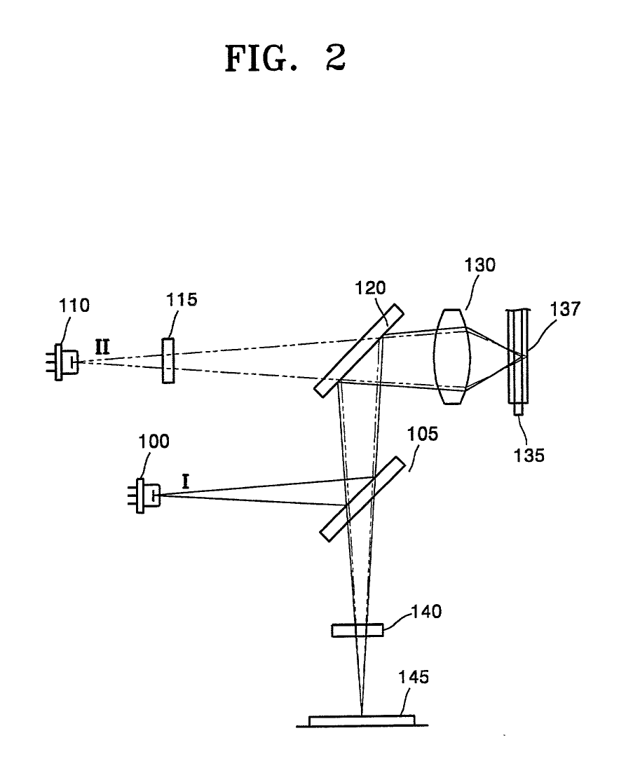

Referring to FIG. 2, an optical pickup apparatus includes first and second light sources 100 and 110 arranged at different positions for emitting light beams having different wavelengths. A first optical path converter 105 reflects or transmits the light beam from the first light source 100. A second optical path converter 120 reflects or transmits the light beam from the second light source 110. An objective lens 130 focuses a divergent light beam from the first or second optical path converters 105 and 120 on a corresponding recording medium. The objective lens 130, as a finite system objective lens, is disposed next to the first optical path converter 105 or the second optical path converter 120 without a conventional collimating lens being interposed.

The optical pickup apparatus of the present invention is a compatible optical pickup apparatus where the corresponding recording medium may be a relatively thin disc 135, for example, a DVD, or a relatively thick disc 137, for example, a CD. Accordingly, the first light source 100 emits a first light beam I having a wavelength of about 650 nm suitable for the relatively thin disc 135. In turn, the second light source 110 emits a second light beam 11 having a wavelength of about 780 nm suitable for the relatively thick disc 137.

Each of the first and second lights I and II is reflected by or passes through the first and second optical path converters 105 and 120, respectively, and is emitted towards the objective lens 130. The objective lens 130 is a finite system objective lens, which enables the divergent light beam from the first and second optical path converters 105 and 120 to be formed on the relatively thin disc 135 or the relatively thick disc 137, respectively. As a result, because the objective lens 130 is used as a finite system objective lens in the present invention, the collimating lens is not needed; thus, the number of components in the optical pickup is less, thereby reducing the size of the optical pickup while providing more free space to other parts.

The first and second optical path converters 105 and 120 may be a first plate beam splitter for correcting aberration and a second plate beam splitter, respectively. A photodetector 145 detects a reproduction signal and/or a servo signal by receiving the divergent light beam reflected on the relatively thick disc 137 or the relatively thin disc 135 and by passing the light beam through the second and first optical path converters 120 and 105.

A grating 115 may be further provided disposed between either the first light source 100 and the first optical path converter 105 or the second light source 110 and the second optical path converter 120. The grating 115 diffracts the incident light beam reflected on the optical recording media into three beams. Also, a condensing lens 140 may be provided to focus the light beam output from the first optical path converter 105 to be received by the photodetector 145.

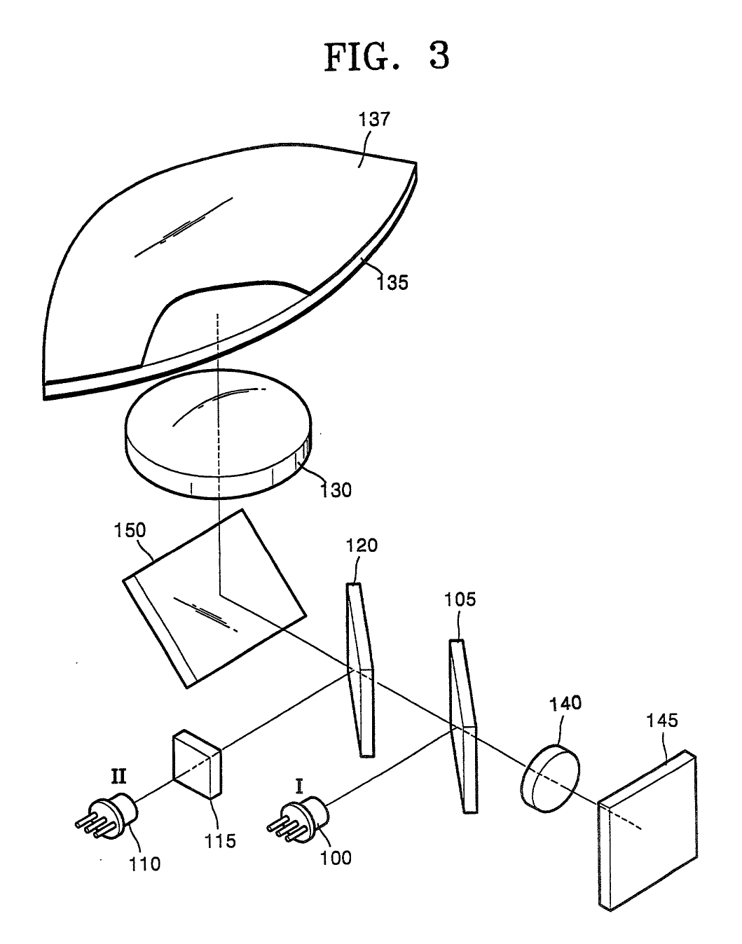

FIG. 3 is a view showing an optical arrangement of an optical pickup apparatus according to another embodiment of the present invention. In the following embodiment, the structures of the first and second light sources 110,115, the first and second optical path converters 105, 120, the grating 115, the objective lens 130, the relatively thin and thick discs 135,137, and the photodetector 145 are substantially the same as those of the embodiment described with reference to FIG. 2, and thus descriptions of these components of the optical pickup apparatus will not be provided in the following embodiment.

A reflection mirror 150 is further provided on the optical path between the objective lens 130 and the first and second optical path converters 105 and 120. Here, the objective lens 130, for example, is a finite system objective lens, which focuses the divergent light beam from the first or second optical path converters 105 and 120 to be formed as a light spot on the optical recording media 135 and 137. Thus, the finite system objective lens 130 is arranged between the reflection mirror 150 and the optical recording media 135 and 137.

In the embodiment of FIG. 2, the first and second light sources 100 and 110 are disposed under the first and second optical path converters 105 and 120, respectively. Thus, in view of the objective lens 130, a length of the optical pickup apparatus in a horizontal direction may be reduced. Also, in the embodiment of FIG. 3, because the first and second light sources 100 and 110 are disposed in a side direction of the first and second optical path converters 105 and 120, in view of the objective lens 130, a width of the optical pickup apparatus in a vertical direction may be reduced.

As described above, in the optical pickup apparatus according to the present invention, because the finite system objective lens for focusing the light passing through or reflected by the first or second optical path converter 105,120 on an optical recording medium is used, a collimating lens is not needed so that the overall volume of the optical pickup apparatus may be reduced. Also, free space can be provided to other components. Further, by reducing the number of components, manufacturing costs may be reduced.

While this invention has been particularly shown and described with reference to preferred embodiments thereof, it will be understood by those skilled in the art that various changes in form and details may be made thereto without departing from the spirit and scope of the invention as defined by the appended claims.

What is claimed is:

1. An optical pickup apparatus, comprising:
first and second light sources emitting first and second light beams, respectively, each light beam comprising a different wavelength;
first and second optical path converters changing optical paths of the first and second light beams, respectively;
an objective lens, arranged next to the first and second optical path converters, focusing a divergent light beam from one of the first and second optical path converters on a corresponding optical recording medium; and
a photodetector receiving the light beams from the first and second optical path converters after being reflected from the optical recording medium.

2. The optical pickup apparatus as claimed in claim 1, wherein at least one of the first and second optical path converters is a plate beam splitter to correct for aberration.

3. The optical pickup apparatus as claimed in claim 2, wherein one of the first and second light beams has a wavelength of about 650 nm and the other one of first and second light beams has a wavelength of about 780 nm.

4. The optical pickup apparatus as claimed in claim 2, further comprising a grating disposed between either the first light source and the first optical path converter or the second light source and the second optical path converter.

5. The optical pickup apparatus as claimed in claim 2, further comprising a condensing lens focusing the light beam output from the first optical path converter to the photodetector.

6. The optical pickup apparatus as claimed in claim 1, wherein one of the first and second light beams has a wavelength of about 650 nm and the other one of first and second light beams has a wavelength of about 780 nm.

7. The optical pickup apparatus as claimed in claim 1, further comprising a grating disposed between either the first light source and the first optical path converter or the second light source and the second optical path converter.

8. The optical pickup apparatus as claimed in claim 1, wherein the corresponding optical recording medium comprises a relatively thin disc or a relatively thick disc, where the first light source emits the first light beam having a wavelength of about 650 nm suitable for the relatively thin disc and the second light source emits the second light beam having a wavelength of about 780 nm suitable for the relatively thick disc.

9. The optical pickup apparatus as claimed in claim 8, wherein the objective lens is a finite system objective lens, which enables the divergent light beam, from the first and second optical path converters, to be formed on the relatively thin disc or the relatively thick disc, respectively.

10. The optical pickup apparatus as claimed in claim 1, wherein the first and second light sources are disposed under the first and second optical path converters, respectively.

11. An optical pickup apparatus, comprising:
first and second light sources emitting first and second light beams, respectively, each light beam comprising a different wavelength;
first and second optical path converters changing optical paths of the first and second light beams, respectively;
an objective lens, arranged next to the first and second optical path converters, focusing a divergent light beam from one of the first and second optical path converters on one of a relatively thin disc and a relatively thick disc; and
a photodetector receiving the light beams from the first and second optical path converters after being reflected by the optical recording medium, wherein the optical pickup is exclusive of a collimating lens.

12. The optical pickup apparatus as claimed in claim 11, further comprising a grating disposed between either the first light source and the first optical path converter or the second light source and the second optical path converter.

13. The optical pickup apparatus as claimed in claim 11, wherein the first light source emits the first light beam having a wavelength of about 650 nm suitable for the relatively thin disc and the second light source emits the second light beam having a wavelength of about 780 nm suitable for the relatively thick disc.

14. The optical pickup apparatus as claimed in claim 13, wherein the objective lens is a finite system objective lens, which enables the divergent light beam, from the first and second optical path converters, to be formed on the relatively thin disc or the relatively thick disc, respectively.

15. The optical pickup apparatus as claimed in claim 11, wherein the first and second light sources are disposed under the first and second optical path converters, respectively.

16. An optical pickup apparatus, comprising:
first and second light sources emitting first and second light beams, respectively, each light beam comprising a different wavelength;
first and second optical path converters changing optical paths of the first and second light beams, respectively;
a reflection mirror, disposed next to the first optical path converter or the second optical path converter, to change the optical path of one of the first and second light beams;
an objective lens, arranged between the reflection mirror and a corresponding optical recording medium, focusing a divergent light beam from one of the first and second optical path converters on the corresponding optical recording medium; and
a photodetector receiving the light beams from the first and second optical path converters after being reflected from the optical recording medium.

17. The optical pickup apparatus as claimed in claim 16, wherein at least one of the first and second optical path converters is a plate beam splitter to correct for aberration.

18. The optical pickup apparatus as claimed in claim 17, wherein one of the first and second light beams has a wavelength of about 650 nm and the other one of first and second light beams has a wavelength of about 780 nm.

19. The optical pickup apparatus as claimed in claim 16, wherein one of the first and second light beams has a wavelength of about 650 nm and the other one of first and second light beams has a wavelength of about 780 nm.

20. The optical pickup apparatus as claimed in claim 16, wherein the corresponding optical recording medium comprises a relatively thin disc or a relatively thick disc, where the first light source emits the first light beam having a wavelength of about 650 nm suitable for the relatively thin disc and the second light source emits the second light beam having a wavelength of about 780 nm suitable for the relatively thick disc.

21. The optical pickup apparatus as claimed in claim 20, wherein the objective lens is a finite system objective lens, which enables the divergent light beam, from the first and second optical path converters, to be formed on the relatively thin disc or the relatively thick disc, respectively.

22. The optical pickup apparatus as claimed in claim 16, wherein the first and second light sources are disposed in a side direction of the first and second optical path converters.

23. An optical pickup apparatus, comprising:
first and second light sources emitting first and second light beams, respectively, each light beam comprising a different wavelength;
first and second optical path converters changing optical paths of the first and second light beams, respectively;
a reflection mirror, disposed next to the first optical path converter or the second optical path converter, to change the optical path of one of the first and second light beams;
an objective lens, arranged between the reflection mirror and a corresponding optical recording medium, focusing a divergent light beam from one of the first and second optical path converters on the corresponding optical recording medium; and
a photodetector receiving the light beams from the first and second optical path converters after being reflected from the optical recording medium, wherein the optical pickup is exclusive of a collimating lens.

24. An optical pickup apparatus, comprising:
first and second light sources emitting first and second light beams, respectively, each light beam comprising a different wavelength;
first and second optical path converters changing optical paths of the first and second light beams, respectively;
a finite system objective lens proximate to a corresponding optical recording medium, focusing a divergent light beam from one of the first and second optical path converters on the corresponding optical recording medium; and
a photodetector receiving the divergent light beam from the first and second optical path converters after being reflected from the optical recording medium.

25. The optical pickup apparatus as claimed in claim 24, wherein the optical pickup is exclusive of a collimating lens.

26. The optical pickup apparatus as claimed in claim 24, wherein at least one of the first and second optical path converters is a plate beam splitter to correct for aberration.

27. The optical pickup apparatus as claimed in claim 24, wherein one of the first and second light beams has a wavelength of about 650 nm and the other one of first and second light beams has a wavelength of about 780 nm.

28. The optical pickup apparatus as claimed in claim 24, wherein the corresponding optical recording medium comprises a relatively thin disc or a relatively thick disc, where the first light source emits the first light beam having a wavelength of about 650 nm suitable for the relatively thin disc and the second light source emits the second light beam having a wavelength of about 780 nm suitable for the relatively thick disc.
